(19) United States
(12) Patent Application Publication
(10) Pub. No.: US 2015/0046458 A1
(43) Pub. Date: Feb. 12, 2015

(54) METHOD FOR RECOMMENDING USERS IN SOCIAL NETWORK AND THE SYSTEM THEREOF

(71) Applicant: TENCENT TECHNOLOGY (SHENZHEN) COMPANY LIMITED, Shenzhen (CN)

(72) Inventor: Peng Hu, Shenzhen (CN)

(21) Appl. No.: 14/386,919

(22) PCT Filed: Mar. 16, 2013
(86) PCT No.: PCT/CN2013/072774

§ 371 Date: Sep. 22, 2014

(30) Foreign Application Priority Data
Mar. 21, 2012 (CN) 201210076533.9

(51) Int. Cl. G06F 17/30; H04L 29/06

(52) U.S. Cl. CPC G06F 17/30598; H04L 65/403
USPC 707/738

(57) ABSTRACT

A method for recommending users in social network is disclosed. The method includes the steps of: obtaining multi-media playing records of the users; establishing group of users with the same interest according to the multimedia playing records of the users; recommending the users in the group of users with the same interest to each other. By obtaining the multimedia playing records of the users, the above method for recommending users in social network sets up group of users with the same interest according to the multimedia playing records of the users and to recommend the users in the group of users with the same interest to each other. By this way, the user will not have to fill out the personal information or to submit labels of interests actively, which improves the operative convenience. In addition, since the user's multimedia played behavior can reflect the user's interest and preference in detail, the above method can recommend users that have more similar interest, increasing the rate of recommendation accuracy. In addition, a system for recommending users in social network is also disclosed.

### FIELD OF THE INVENTION

The present invention relates to the field of Internet technology, and more particularly relates to a method for recommending users in social network and the system thereof.

### BACKGROUND OF THE INVENTION

Social Networking Services (SNS) refers to Internet application services that help people to build up their own social network. SNS is used to establish friendship chains, to share information and knowledge, to communicate with others and exchange views, and to help each other. Therefore, SNS is getting more and more important in people's daily life and work.

In SNS, a user would have a need to know new friends, especially to know those who have the same or similar interests with him. Users with same or similar interest are called as users of the same interest. As a platform for information exchanging, SNS provides various ways to recommend other users having the same interest to the user.

The existing SNS usually match users according to their interests in personal information filled out or labels of interests submitted by the users themselves, and then recommend users in the matching result having the same or similar interests to other users.

However, traditional methods for recommending users require the user to fill out the personal information or to submit labels of interests actively, which is not convenient for the user in operation. Moreover, the interests in personal information filled out by the user or labels of interests may not reflect the user's preference in detail. Thus, the accuracy of the traditional methods is low.

Therefore, heretofore unaddressed needs exist in the art to address the afore-mentioned deficiencies and inadequacies.

### SUMMARY OF THE INVENTION

It is an object of the present invention to provide a method for recommending users in social network which can improve the convenience in operation and increase the accuracy for recommending users with the same interest.

According to an aspect of the invention, a method for recommending users in social network includes the steps of:

obtaining, by a server, multimedia playing records of the users;

establishing, by the server, a group of users with the same interest according to the multimedia playing records of the users; and

recommending, by the server, users in the group of users with the same interest to each other.

Preferably, before the step of obtaining the multimedia playing records of the users, the method further includes:

obtaining, by a multimedia player application, a user identity of a social networking application and playing records corresponding to the user identity;

and the step of obtaining the multimedia playing records of the users includes receiving, at the server, the user identity and the playing records corresponding to the user identity sent by the multimedia player application.

Preferably, before the step of obtaining the playing records of users, the method further includes:

obtaining, by the multimedia player application device, a device identity of a multimedia player and playing records corresponding to the device identity of the multimedia player; and

obtaining, by a social networking application, a device identity of networking device and a user identity of a user suing the networking application, the user identity corresponding to the device identity of the networking device;

the step of obtaining multimedia playing records of the users includes:

receiving, at the server, the device identity of the multimedia player and corresponding playing records sent by the multimedia player application, and the device identity of the networking device and the corresponding user identity sent by the social networking application; and

obtaining, at the server, the user identity and the playing records corresponding to the user identity.

Preferably, the multimedia playing records of the users include the user identity and the playing records; the playing records include one or more of: name of multimedia file, identity of multimedia file, duration of multimedia file and current playing duration.

Preferably, the multimedia playing records further include total number of times played recently, type of multimedia file and quality information of multimedia file.

Preferably, the step of establishing group of users with the same interest according to the multimedia playing records of the users includes:

obtaining samples for cluster analysis from the multimedia playing records of the users; and

clustering the samples for cluster analysis according to the preset clustering parameters, such that the users of the same cluster are classified into the same group of users with the same interest.

Preferably, clustering the samples for cluster analysis according to the preset clustering parameters includes classifying users whose duration or number of times in playing the same multimedia file exceeds a predetermined threshold into one cluster.

Optionally, clustering the samples for cluster analysis according to the preset clustering parameters includes classifying users whose duration or number of times in playing the same collection of multimedia files exceeds a predetermined threshold into one cluster.

Optionally, clustering the samples for cluster analysis according to the preset clustering parameters includes classifying users whose duration or number of times in playing the same type of multimedia files exceeds a predetermined threshold into one cluster.

According to another further aspect of the invention, a system for recommending users in social network which can improve the convenience in operation and increase the accuracy for recommending users with the same interest is provided.

The system for recommending users in social network includes:

a playing record obtaining module, configured to obtain multimedia playing records of the users;

a user group establishing module, configured to set up a group of users with the same interest according to the multimedia playing records of the users;

a recommending module, configured to recommend the other users in the group of users with the same interest to each other.

Preferably, the system may further include:

a first multimedia player module, configured to obtain user identity of social networking application and the playing records corresponding to the user identity;

and the playing record obtaining module is configured to receive the user identity and the playing records corresponding to the user identity sent by the first multimedia player module.

Preferably, the system may further include:

a second multimedia player module, configured to obtain device identity of multimedia player and the playing records corresponding to the device identity of multimedia player; and

a social networking application module, configured to obtain the device identity of networking application and the user identity of the user using the networking application, the user identify corresponding to the device identity of networking application;

and the playing record obtaining module is configured to receive the device identity of multimedia player and the corresponding playing records sent by the second multimedia player module, and the device identity of social networking application and the corresponding user identity, so as to obtain the user identity and the playing records corresponding to the user identity.

Preferably, the multimedia playing records of the users may include the user identity and the playing records. The playing records include one or more of: name of multimedia file, identity of multimedia file, duration of multimedia file and current playing duration.

Preferably, the multimedia playing records may further include total number of times played recently, type of multimedia file and quality information of multimedia file.

Preferably, the user group establishing module may be configured to obtain the preset clustering parameters, to extract samples for cluster analysis from the multimedia playing records of the users according to the clustering parameters, and to cluster the users based on the samples for cluster analysis, so as to classify users in the same cluster into the same group of users with the same interest.

Preferably, the user group establishing module may be configured to cluster the users whose duration or number of times in playing the same multimedia file exceeds a pre-determined threshold into one cluster.

Optionally, the user group establishing module may be configured to cluster the users whose duration or number of times in playing the same collection of multimedia files exceeds a predetermined threshold into one cluster.

Optionally, the user group establishing module may be configured to cluster the users whose duration or number of times in playing the same type of multimedia files exceeds a predetermined threshold into one cluster.

By obtaining the multimedia playing records of the users, the above method and system for recommending users in social network is configured to set up group of users with the same interest according to the multimedia playing records of the users and to recommend the users with the same interest in the group to each other. By this way, the user doesn't have to fill out the personal information or to submit labels of interests actively, which improves the operative convenience. Since the user's multimedia played behavior can reflect the user's interest and preference in detail, this invention can recommend users that have more similar interest, increasing the rate of recommendation accuracy.

### BRIEF DESCRIPTION OF THE DRAWINGS

FIG. 1 is an explanatory flow chart of a method for recommending users in social network in one embodiment of the present invention.

FIG. 2 is an explanatory drawing of application scene of the method for recommending users in social network in one embodiment of the present invention.

FIG. 3 is an explanatory structural diagram of a system for recommending users in social network in one embodiment of the present invention.

FIG. 4 is an explanatory structural diagram of a system for recommending users in social network in another embodiment of the present invention.

FIG. 5 is an explanatory structural diagram of a system for recommending users in social network in yet another embodiment of the present invention.

### DETAILED DESCRIPTION OF THE PREFERRED EMBODIMENTS

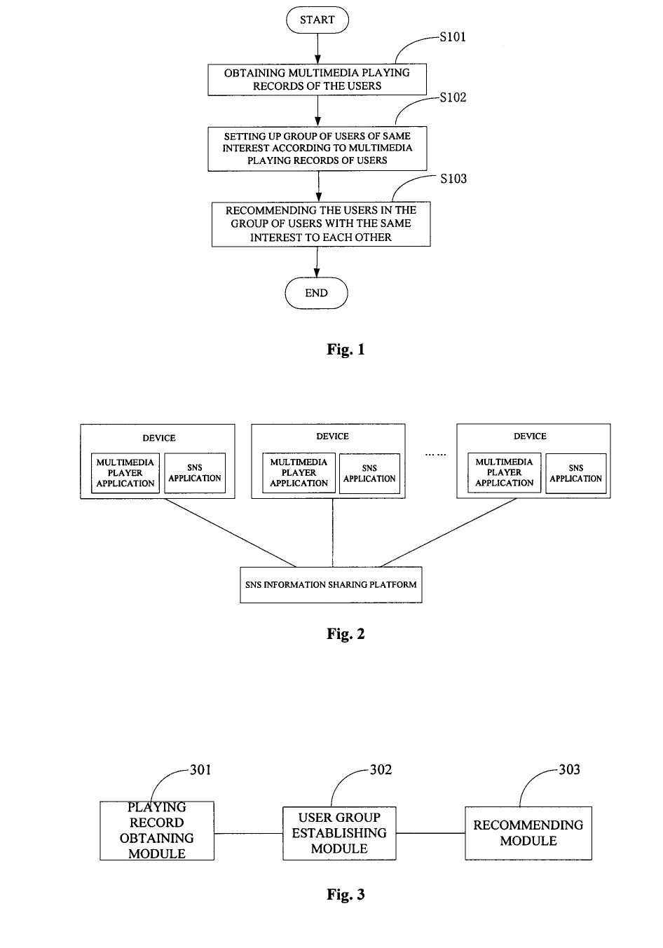

As shown in FIG. 1, a method for recommending users in social network in one embodiment includes the following steps.

Step S100: obtaining, by a server, multimedia playing records of the users.

In one embodiment, the multimedia playing records include user identity and playing records corresponding to the user identity. The playing records include one or more of: name of multimedia file, identity of multimedia file, duration of multimedia file and current playing duration.

The multimedia playing records may further include total number of times played recently, type of multimedia file and quality information of multimedia file.

In one embodiment, the message digest value (such as SHA value and MD5 value) or

Hash Value of full text of multimedia file can be obtained as identity of multimedia file. The quality information of multimedia file includes: code stream, resolution, audio sampling rate of the multimedia. The name of a film or a piece of music refers to the name of the film or music contained in the multimedia file. The type of a film or a piece of music includes film types and music types. The film types may include suspense, comedy, action, emotional and idol, etc. The music types may include pop and classical, etc. The playing duration can be the total playing duration of the multimedia file.

Step S102: establishing, by the server, group of users with the same interest according to the multimedia playing records of the users.

Users with the same interest refer to the users who have the same or similar interest and preference. A group of users with the same interest refers to the group consisting of users who have the same or similar interest. The playing records of multimedia file can reflect the user's interest and preference. Therefore, it is possible to set up a group of users with the same interest according to user's multimedia playing records.

In one embodiment, the samples for cluster analysis from the multimedia playing records of the users are obtained, and then clustered according to the preset clustering parameters, such that users in the same cluster are classified into the same group of users with the same interest.

Specifically, in one embodiment, the multimedia playing records of the users are processed and counted to obtain the samples for cluster analysis. For example, by summing up the number of times played and playing duration of the same film or piece of music by the same user, or counting the number of times the high-resolution film or music has been played or the percentage of users who has played high-resolution film or music, or counting the number of times a certain type of film or music has been played, the samples for cluster analysis are obtained.

Furthermore, the mass samples for cluster analysis can be clustered. Specifically, in one embodiment, the traditional clustering method can be used to cluster the samples for cluster analysis according to the preset clustering parameters. Furthermore, the users of the samples in the same cluster are classified into one type, i.e. into the same group of users with the same interest. Samples with distance between each other smaller than a preset threshold are regarded to be in the same cluster. Different clustering parameters can lead to different clustering results.

In one embodiment, the clustering parameters can be set as combination of any attributes of the multimedia playing records. For example, the clustering parameters can be set as the number of times each type of film or music has been played. According to this clustering parameter, samples with similar number of times in watching each type of film or music are clustered together. In addition, the clustering parameters can also be set as others, such as the name of a film or a piece of music, i.e. to cluster the samples according to the name of film or music, such that samples containing the same name of film or music are clustered together. The clustering parameters can also be set as the name of film or music and the number of times the film or music has been played, such that samples of close number of times the same film or music has been played are clustered together. Furthermore, samples in the clustering results with distance between each other smaller than preset threshold are classified into one type.

In one embodiment, the group of users with the same interest can be set up based on specific resources. For example, if it is found that the user has played the same film, the same episode of a TV series or the same music from an album for a certain time over the threshold (e.g., the video has been played for over 10 minutes, or the music has been played over twice), then these users are clustered into one group. For any user in this group, it is possible to choose a number of other users to recommend.

In one embodiment, the group of users with the same interest may be established based on specific collection of multimedia. If it is found that the duration of the user in watching the same film (including several pieces of film with the same film name), the same TV series (including several episodes) or the same music album (including several pieces of music) reaches the threshold (for example, the video has been played for over 10 minutes, or the music has been played over twice), then these users are clustered into one group. For any user in this group, it is possible to choose a number of other users to recommend.

In one embodiment, the group of users with the same interest may be established based on specific type of film/music. If it is found that the user has played the same type of TV series or the same type of music for a certain time over the threshold (e.g., the video has been played for over 10 minutes, or the music has been played over twice), then these users are clustered into one group. For any user in this group, it is possible to choose a number of other users to recommend.

Step 103: recommending, by the server, the users in the group of users with the same interest to each other.

In one embodiment, it is possible to recommend users in the group of users with the same interest to each other, or to recommend the most similar users in the clustered results to each other. For example, User A, User B and User C belong to the same group of users with the same interest, then it is possible to push to User A the message such as “User B and User C also like the film, pay attention to them?”, in the meantime providing with links to the users recommended.

In one embodiment, before the step S101, the user identity of social networking application and the playing records corresponding to the user identity can be obtained by the multimedia player application.

In one embodiment, the multimedia player application is the multimedia player client or the multimedia player application embedded into webpage. The SNS application can be application client (such as an instant messaging client and a social networking platform), or SNS application in webpage. In one embodiment, the multimedia player application and the SNS application can be different clients, or can be different applications in the same webpage.

Specifically, in one embodiment, the multimedia player application can obtain its playing records, further search the computer (i.e. the device which has the multimedia player application) for the SNS application, and interprocess-communicate with SNS application to obtain the identity of the user using the SNS application. In another embodiment, the multimedia player application can search the computer for the configuration files of the SNS application, and analyze the configuration files to obtain the identity of the user using the SNS application. The user identity and playing records obtained from the same device are corresponding to each other.

In one embodiment, the multimedia player application can be provided with a multimedia information share module to obtain the user identity of the SNS application and the playing records corresponding to the user identity.

Furthermore, the user identity of the SNS application and the playing records corresponding to the user identity can be encapsulated into data packet, which will be sent to the SNS information sharing platform to set up the group of users with the same interest.

Furthermore, in the step S101, the user identity and the playing records corresponding to the user identity sent by the multimedia player application may be received. Specifically, the data packet sent by the multimedia player application may be received and analyzed by the SNS information sharing platform, such that the user identity and playing records corresponding to the user identity, i.e. the user multimedia playing records, are obtained.

In this embodiment, by obtaining the identity of the user using SNS application and the multimedia playing records of the same device, the multimedia playing records of the user using the SNS application can be obtained conveniently and accurately, so as to further set up the group of user with the same interest according to the multimedia playing records of the users and to recommend the users. By obtaining the user's correct multimedia playing records, the accuracy for establishing group of users with the same interest is increased, consequently increasing the accuracy of the recommendation of users with the same interest in social network.

In another embodiment, before the step S101, the device identity of multimedia player and the playing records corresponding to the device identity of multimedia player can be obtained by the multimedia player application, and the device identity of networking application and the user identity of the user using the networking application, the user identify corresponding to the device identity of networking application can be obtained by social networking application.

In one embodiment, the multimedia play device or networking application device, i.e. the device that has multimedia player application or SNS application, includes desktop computer, notebook PC, tablet PC, media player and mobile phones, etc. The device identity of multimedia player refers to the sequence number that uniquely identifying the multimedia play device. The device identity of networking application refers to the sequence number that uniquely identifying the networking application device, such as MAC address, IP address of the computer and the sequence number of mobile phones, etc.

Specifically, when the multimedia is played at the multimedia application, the multimedia application can obtain its playing records and the device identity of multimedia player, and the device identity of multimedia player and the playing records are corresponding to each other. Furthermore, the device identity of multimedia player and its corresponding playing records obtained are sent to the SNS information sharing platform.

Specifically, when the user is using the SNS application in networking application device, the identity of the user using the SNS application and the device identity of networking application can be obtained by the SNS application, wherein the device identity of networking application and the user identity are corresponding to each other. Furthermore, the SNS application can send the obtained networking application device identity and the corresponding identity of the user using the SNS application to the SNS information sharing platform.

Furthermore, the specific process of step S101 can be that: receiving the device identity of multimedia player and the corresponding playing records sent by the multimedia player application, and the device identity of networking application and the corresponding user identity sent by the social networking application, and obtaining the user identity and the corresponding playing records.

The SNS information sharing platform receives data from different devices. According to the device identity of multimedia player and the corresponding playing records, as well as the device identity of networking application and the corresponding user identity, the SNS information sharing platform sets “device identity of multimedia player and device identity of networking application are the same” as the matching condition, to obtain the user identity and the corresponding playing records, i.e. the user's multimedia playing records.

In this embodiment, by obtaining the identity of the user using SNS application and the multimedia playing records of the same device, the multimedia playing records of the user using SNS application can be obtained conveniently and accurately, so as to further set up the group of user with the same interest according to the multimedia playing records of the users and to recommend the users. The multimedia playing records of the user using SNS application can be obtained without the SNS application and the multimedia player application running spontaneously, which facilitate the obtaining of the user identity and the multimedia playing records.

The above method for recommending users in social network will be described by a specific application scene. As shown in FIG. 2, a plurality of devices provided with multimedia player application and SNS application are configured to interact with the SNS information sharing platform, which resides on a server. In one embodiment, the specific process of the method for recommending users in social network includes:

(1) The multimedia player application obtains its playing records, and searches the device which has the multimedia application for SNS application to obtain the identity of the user using SNS application. The user identity and the playing records obtained from the same device are corresponding to each other. Furthermore, the user identity and the corresponding playing records obtained are sent to the SNS information sharing platform on a server.

(2) The SNS information sharing platform receives the user identity and the corresponding playing records, i.e. the multimedia playing records of the users.

(3) The SNS information sharing platform sets up the group of users with the same interest according to the multimedia playing records of the users, and recommends the users in the group of users with the same interest to each other.

In another embodiment, the specific process of the method for recommending users in social network includes:

(1) The multimedia player application obtains the playing records and the identity of the device which has the multimedia player application and sends the device identity and the playing records to the SNS information sharing platform;

(2) The SNS application obtains the identity of the user using the SNS application and the identity of the device which has the multimedia player application, and send the obtained device identity and user identity to the SNS information sharing platform;

(3) The SNS information sharing platform receives the device identity and the corresponding playing records sent by the multimedia player application, as well as the device identity and the corresponding user identity sent by the SNS application, and sets “same device identity” as the matching condition, so as to obtain the user identity and the corresponding playing records, i.e. the multimedia playing records of the users.

(4) The SNS information sharing platform sets up group of users with the same interest according to the user's multimedia play records, and recommends the users in the group of users with the same interest to each other

As shown in FIG. 3, in one embodiment, a system for recommending users in social network includes a playing record obtaining module 301, a user group establishing module 302 and a recommending module 303. The playing record obtaining module 301 is configured to obtain the multimedia playing records of the users.

In one embodiment, the multimedia playing records of the users include the user identity and the playing records corresponding to the user identity. The playing records include combination of one or more of the followings: name of multimedia file, identity of multimedia file, duration of multimedia file and current playing duration.

In one embodiment, the multimedia playing records may further include total number of times played recently, type of multimedia file and quality information of multimedia file.

In one embodiment, the message digest value (such as SHA value and MD5 value) or Hash Value of full text of multimedia file can be obtained as identity of multimedia file. The quality information of multimedia file includes: code stream, resolution, audio sampling rate of the multimedia. The name of a film or a piece of music refers to the name of the film or music contained in the multimedia file; the type of film or music includes film types and music types. The film types may include suspense, comedy, action, emotional and idol, etc. while the music types may include pop and classical, etc. The playing duration can be the total playing duration of the multimedia file.

The user group establishing module 302 is configured to set up a group of users with the same interest according to the multimedia playing records of the users.

Users with the same interest refer to the users who have the same or similar interest and preference. A group of users with the same interest refers to the group consisting of users who have the same or similar interest. The playing records of multimedia file can reflect the user's interest and preference. Therefore, it is possible to set up group of users with the same interest according to user's multimedia playing records.

In one embodiment, the user group establishing module 302 can obtain the samples for cluster analysis from the multimedia playing records of the users, and then cluster the samples according to the preset clustering parameters to classify users of the same cluster into the same group of users with the same interest.

Specifically, in one embodiment, the user group establishing module 302 can firstly process and count the multimedia playing records of the users to obtain the samples for cluster analysis. For example, by summing up the number of times played and playing duration for the same film or music by the same user, or counting the number of times the high-resolution film or music has been played or the percentage of users who has played high-resolution film or music, or counting the number of times a certain type of film or music has been played, the samples for cluster analysis are obtained.

Furthermore, the user group establishing module 302 can cluster the mass samples for cluster analysis. Specifically, in one embodiment, traditional clustering method can be used to cluster the samples for cluster analysis according to the preset clustering parameters, and to further classify the users in samples of the same cluster into one type, i.e. into the same group of users with the same interest. Samples with distance between each other smaller than preset threshold are regarded to be in the same cluster. Different clustering parameters can lead to different clustering results.

In one embodiment, the clustering parameters can be set as combination of any attributes of the multimedia playing records. For example, the clustering parameters can be set as the number of times each type of film or music has been played. According to this clustering parameter, samples with similar number of times in watching each type of film or music are clustered together. In addition, the clustering parameters can also be set as others, such as the name of a film or a piece of music, i.e. to cluster the samples according to the name of film or music, such that samples containing same name of film or music are clustered together. The clustering parameters can also be set as the name of film or music and the number of times the film or music has been played, such that samples of close number of times the same film or music has been played are clustered together. Furthermore, samples in the clustering results with distance between each other smaller than preset threshold are classified into one type.

In one embodiment, the user group establishing module 302 may be configured to set up group of users with the same interest based on specific resources. If it is found that the user has played the same film, the same episode of a TV series or the same music from an album for a certain time over the threshold (e.g., the video has been played for over 10 minutes, or the music has been played over twice), then these users are clustered into one group. For any user in this group, it is possible to choose a number of other users to recommend.

In one embodiment, the user group establishing module 302 may be configured to set up group of users with the same interest based on specific collection of multimedia: if it is found that the user has played the same film file (including several pieces of film with the same film name), the same TV series (including several episodes) or the same music album (including several pieces of music) for a certain time over the threshold (e.g., the video has been played for over 10 minutes, or the music has been played over twice), then these users are clustered into one group. For any user in this group, it is possible to choose a number of other users to recommend.

In one embodiment, the user group establishing module 302 may be configured to set up group of users with the same interest based on specific type of film/music. If it is found that the user has played the same type of TV series or the same type of music for a certain time over the threshold (for example, the video has been played for over 10 minutes, or the music has been played over twice), then these users are clustered into one group. For any user in this group, it is possible to choose a number of other users to recommend.

The recommending module 303 is configured to recommend the users in the group of users with the same interest to each other.

In one embodiment, it is possible to recommend the users in the group of users with the same interest to each other, or to recommend the most similar users in the clustered results to the user in the group of users with the same interest. For example, User A, User B and User C belong to the same group of users with the same interest, then it is possible to push to User A the message such as “User B and User C also like the film, pay attention to them?”, and provide with links to the users recommended.

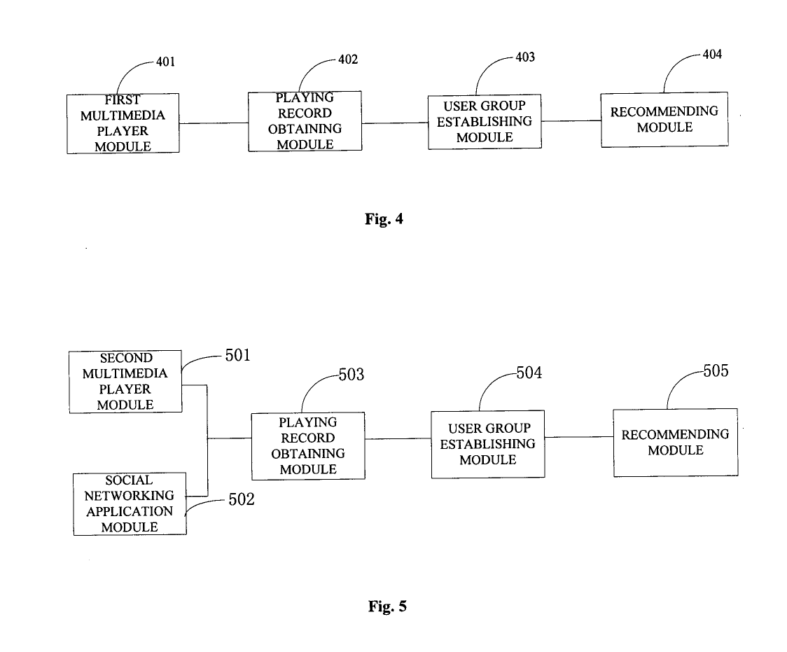

As shown in FIG. 4, in one embodiment, a system for recommending users in social network includes a first multimedia player module 401, a playing record obtaining module 402, a user group establishing module 403 and a recommending module 404. The playing record obtaining module 401 is configured to obtain the user identity of the social network application and the playing records corresponding to the user identity. The playing record obtaining module 402, together with the user group establishing module 403 and the recommending module 404, reside on a server and function as an SNS information sharing platform.

In one embodiment, the multimedia player application is the multimedia player client or the multimedia player application embedded into webpage. The SNS application can be application client (such as instant messaging client and friends platform), or SNS application in webpage. In one embodiment, the multimedia player application and the SNS application can be different clients, or can be different applications in the same webpage.

Specifically, in one embodiment, the first multimedia player module 401 can obtain the playing records of the multimedia player application, further search the computer which has the multimedia player application for SNS application, and interprocess-communicate with SNS application to obtain the identity of the user using the SNS application. In another embodiment, the first multimedia player module 401 can search the device which has the multimedia player application for the configuration files of the SNS application, and analyze the configuration files to obtain the identity of the user using the SNS application. The user identity and playing records obtained from the same device are corresponding to each other.

Furthermore, the first multimedia player module 401 can encapsulate the user identity of the SNS application and the playing records corresponding to the user identity into data packet, and send it to the playing record obtaining module 402 to set up the group of users with the same interest.

The playing record obtaining module 402 is configured to receive the user identity and the playing records corresponding to the user identity sent by the first multimedia player module 401.

Specifically, the playing record obtaining module 402 is configured to receive the data packet sent by the first multimedia player module 401, and analyze it to obtain the user identity and corresponding playing records, i.e. the users' multimedia playing records.

The user group establishing module 403 is configured to set up the group of users with the same interest according to the multimedia playing records of the users.

The recommending module 404 is configured to recommend the other users in the group of users with the same interest to each other.

In this embodiment, by obtaining the identity of the user using SNS application and the multimedia playing records of the same device, the multimedia playing records of the user using SNS application can be obtained conveniently and accurately, so as to further set up the group of user with the same interest according to the multimedia playing records of the users and to recommend the users. By obtaining the multimedia playing records of the users, the accuracy of the group of users with the same interest is increased, consequently increasing the accuracy of the recommendation of users with the same interest in social network.

As shown in FIG. 5, in one embodiment, a system for recommending users in social network includes a second multimedia player module 501, a social networking application module 502, a playing record obtaining module 503, a user group establishing module 504 and a recommending module 505. The second multimedia player module 501 is configured to obtain the device identity of multimedia player and the playing records corresponding to the device identity of multimedia player.

The social networking application module 502 is configured to obtain the device identity of networking application and the identity of the user using social network corresponding to the device identity of networking application.

The playing record obtaining module 503, together with the user group establishing module 504 and the recommending module 505, reside on a server and function as an SNS information sharing platform.

In one embodiment, the multimedia play device or networking application device, i.e. the device that has multimedia player application or SNS application, includes desktop computer, notebook PC, tablet PC, media player and mobile phones, etc. The device identity of multimedia player refers to the sequence number that uniquely identifying the multimedia play device. The device identity of networking application refers to the sequence number that uniquely identifying the networking application device, such as MAC address, IP address of the computer and the sequence number of mobile phones, etc.

Specifically, when the multimedia is played by the multimedia application, the second multimedia player module 501 can obtain the playing records of the multimedia player application and the device identity of multimedia player, and the device identity of multimedia player and the playing records are corresponding to each other. Furthermore, the second multimedia player module 501 can send the obtained device identity of multimedia player and its corresponding playing records to the playing record obtaining module 503.

Specifically, when the user is using the SNS application in networking application device, the social networking application module 502 can obtain the identity of the user using the SNS application and the device identity of networking application, and the device identity of networking application is corresponding to the user identity. Furthermore, the social networking application 502 can send the obtained networking application device identity and the corresponding identity of the user using the SNS application to the playing record obtaining module 503.

The playing record obtaining module 503 is configured to receive the device identity of multimedia player and the corresponding playing records sent by the second multimedia player module 501, and the device identity of networking application and the corresponding user identity sent by the social networking application module 502, so as to obtain the user identity and the playing records corresponding to the user identity.

Specifically, according to the device identity of multimedia player device identity and the corresponding playing records, as well as the device identity of networking application and the corresponding user identity, the playing record obtaining module 503 can set “same device identity” as matching condition and obtain the user identity and the playing records corresponding to the user identity, i.e. the multimedia playing records of the users.

The user group establishing module 504 is configured to set up group of users with the same interest according to the multimedia playing records of the users.

The recommending module 505 is configured to recommend the users in the group of users with the same interest to each other.

In this embodiment, by obtaining the identity of the user using SNS application and the multimedia playing records of the same device, the multimedia playing records of the user using SNS application can be obtained conveniently and accurately, so as to further set up the group of user with the same interest according to the multimedia playing records of the users and to recommend the users. The multimedia playing records of the user using SNS application can be obtained without the SNS application and the multimedia player application running spontaneously, which facilitate the obtaining of the user identity and the multimedia playing records.

By obtaining the multimedia playing records of the users, the above method and system for recommending users in social network is configured to set up group of users with the same interest according to the multimedia playing records of the users and to recommend the other users in the group of users with the same interest to each other. By this way, the user will not have to fill out the personal information or to submit labels of interests actively, which improves the operative convenience. In addition, since the user's multimedia played behavior can reflect the user's interest and preference in detail, the above method can recommend users that have more similar interest, increasing the rate of recommendation accuracy.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

1. A method for recommending users in social network, comprising:
obtaining, by a server, multimedia playing records of the users;
establishing, by the server, a group of users with the same interest according to the multimedia playing records of the users; and
recommending, by the server, users in the group of users with the same interest to each other;
wherein the multimedia playing records of the users include the user identity and the playing records, and the playing records comprises one or more of: name of multimedia file, identity of multimedia file, duration of multimedia file and current playing duration.

2. The method of claim 1, wherein before obtaining the multimedia playing records of the users, the method further comprises:
obtaining, by a multimedia player application, a user identity of a social networking application and playing records corresponding to the user identity;
wherein obtaining the multimedia playing records of the users comprises receiving, at the server, the user identity and the playing records corresponding to the user identity sent by the multimedia player application.

3. The method of claim 1, wherein before obtaining the multimedia playing records of the users, the method further comprises:
obtaining, by a multimedia player application, a device identity of a multimedia player and playing records corresponding to the device identity of the multimedia player; and
obtaining, by a social networking application, a device identity of networking device and a user identity of a user using the social networking application, the user identify corresponding to the device identity of the networking device;
wherein obtaining the multimedia playing records of the users comprises:
receiving, at the server, the device identity of the multimedia player and corresponding playing records sent by the multimedia player application, and the device identity of the networking device and the corresponding user identity sent by the social networking application; and
obtaining, at the server, the user identity and the playing records corresponding to the user identity.

4. (canceled)

5. The method of claim 41, wherein the playing records further comprise one or more of: total number of times played recently, type of multimedia file and quality information of multimedia file.

6. The method of claim 1, wherein establishing groups of users with the same interest according to the multimedia playing records of the users comprises:
obtaining samples for cluster analysis from the multimedia playing records of the users; and
clustering the samples for cluster analysis according to the preset clustering parameters, such that the users in the same cluster are classified into the same group of users with the same interest.

7. The method of claim 6, wherein clustering the samples for cluster analysis according to the preset clustering parameters comprises classifying users whose duration or number of times in playing the same multimedia file exceeds a predetermined threshold into one cluster.

8. The method of claim 6, wherein clustering the samples for cluster analysis according to the preset clustering parameters comprises classifying users whose duration or number of times in playing the same collection of multimedia files exceeds a predetermined threshold into one cluster.

9. The method of claim 6, wherein the clustering the samples for cluster analysis according to the preset clustering parameters comprises classifying users whose duration or number of times in playing the same type of multimedia files exceeds a predetermined threshold into one cluster.

10. A system for recommending users in social network, comprising:
a playing record obtaining module, configured to obtain the multimedia playing records of the users;
a user group establishing module, configured to set up a group of users with the same interest according to the multimedia playing records of the users; and
a recommending module, configured to recommend the users in the group of users with the same interest to each other;
wherein the multimedia playing records of the users comprise the user identity and the playing records, and the playing records comprise one or more of: name of multimedia file, identity of multimedia file, duration of multimedia file and current playing duration.

11. The system of claim 10, further comprising:
a first multimedia player module, configured to obtain a user identity of the social networking application and the playing records corresponding to the user identity;
wherein the playing record obtaining module is configured to receive the user identity and the playing records corresponding to the user identity sent by the first multimedia player module.

12. The system of claim 10, further comprising:
a second multimedia player module, configured to obtain a device identity of a multimedia player and the playing records corresponding to the device identity of the multimedia player; and
a social networking application module, configured to obtain a device identity of a networking device and a user identity of the user using the networking application, the user identify corresponding to the device identity of networking application;
wherein the playing record obtaining module is configured to receive the device identity of multimedia player and the corresponding playing records sent by the second multimedia player module, and the device identity of social networking application and corresponding user identity sent by the social networking application module, so as to obtain the user identity and the playing records corresponding to the user identity.

13. (canceled)

14. The system of claim 10, wherein the multimedia playing records further comprise total number of times played recently, type of multimedia file and quality information of multimedia file.

15. The system of claim 10, wherein the user group establishing module is configured to obtain the preset clustering parameters, and to extract samples for cluster analysis from the multimedia playing records of the users according to the clustering parameters, and to cluster the users based on the samples for cluster analysis, so as to classify users in the same cluster into the same group of users with the same interest.

16. The system of claim 15, wherein the user group establishing module is configured to cluster the users whose duration or number of times in playing the same multimedia file exceeds a predetermined threshold into one cluster.

17. The system of claim 15, wherein the user group establishing module is configured to cluster the users whose duration or number of times in playing the same collection of multimedia files exceeds the threshold into one cluster.

18. The system of claim 15, wherein the user group establishing module is configured to cluster the users whose duration or number of times in playing the same type of multimedia files exceeds the threshold into one cluster.
